(19) United States
(12) Patent Application Publication
(10) Pub. No.: US 2006/0256079 A1
(43) Pub. Date: Nov. 16, 2006

(54) Notebook computer input equipment having waterproof and dustproof structure

(75) Inventor: Shin-Han Wu, Taipei (TW)

Correspondence Address: BACON & THOMAS, PLLC, 625 SLATERS LANE, FOURTH FLOOR, ALEXANDRIA, VA, 22314, US

(73) Assignee: Twinhead International Corp., Taipei (TW)

(21) Appl. No.: 11/358,085

(22) Filed: Feb. 22, 2006

(30) Foreign Application Priority Data
May 12, 2005 (TW) 094207689

(51) Int. Cl. G09G 5/00

(52) U.S. Cl. 345/156

(57) ABSTRACT

A notebook computer input equipment having waterproof and dustproof structure includes an input equipment including input keys such as mouse function keys, reel keys and touchpad. A suitable compressed frame is located under the input keys and provided with a prescribed hole for exposing the touchpad on middle part. A suitable cushion is located under the compressed frame and provided with a prescribed opening for exposing the touchpad. A suitable compressed bar is located under the compressed frame and above the touchpad and provided with a prescribed aperture for exposing the touchpad. A notebook palmrest is provided with a prescribed cavity. Thus, a notebook computer input equipment having the waterproof and dustproof effects is achieved.

### BACKGROUND OF THE INVENTION

1. Field of the Invention

The present invention relates in general to a notebook computer input equipment having waterproof and dustproof structure. In particular, the present invention relates to a notebook computer input equipment having waterproof and dustproof input keys which are integrated together with the notebook to achieve the waterproof and dustproof effects.

2. Description of Related Art

Recently, the electronics and information industries are developed very fast and a small and short notebook computer is an important developing field for the industry. Generally, a personal computer for use in house is immobile (the location of the computer is fixed). The pollution source in house is stable so that the pollution problem during working is not specially considered. A notebook is emphasized to its portability, it has a small volume and requires precision. Because its working time in mobile environment (outdoors) is increased, it is liable to be affected by outside factors (such as water and dust) to pollute its inside components. Among others, the palmrest, and the input keys such as the touchpad (most frequently touched by users), mouse keys and reel keys are most liable to be damaged by environment. If the structural design of the joint for the input keys and the notebook is not good, water and dust are liable to invade into the notebook to pollute the components inside and affect the operation of the input keys and computer life.

A prior art input equipment assembly for notebook shown in FIG. 1 includes: a prescribed hole 10 for input equipment (not shown) on the palmrest; an input pad having a touchpad 12, at least one mouse key 13 and a reel key 14 mounted in the prescribed hole (not shown); a circuit board 15 located under the input keys and including prior art processing circuit to receive operation orders. According to the prior art input equipment, the joint 16 combining prescribed hole of palmrest 10 and touchpad 12, mouse key 13 and reel key 14 are liable to be invaded by water and dust causing damage to circuit board 15 located inside.

Therefore, to provide an input equipment that is integrated together with the notebook to achieve waterproof and dustproof effects is an important object of the present invention.

### SUMMARY OF THE INVENTION

In view of the problem that prior art notebook computer cannot prevent from outside pollution (such as water and dust), the present invention provides a notebook computer input equipment having waterproof and dustproof structure to achieve the waterproof and dustproof effects.

Accordingly, the main object of the invention is to provide a waterproof and dustproof structure for a notebook computer input equipment in which a suitable compressed frame, a suitable cushion, and a suitable compressed bar located under the input equipment of the notebook computer such as touchpad, the mouse keys and reel keys are combined with a prescribed cavity on the palmrest of the notebook computer to achieve the waterproof and dustproof effects.

### BRIEF DESCRIPTION OF THE DRAWINGS

The present invention can be more fully understood by reading the subsequent detailed description and examples with references made to the accompanying drawings, wherein:

FIG. 1 is a cross-section view of prior art input equipment assembly;

FIG. 2 is a cross-section view of the input equipment according to the present invention;

FIG. 3a is a front view of a suitable frame according to the present invention;

FIG. 3b is a side view of a suitable frame according to the present invention;

FIG. 4 is a front view of a prescribed hole for input equipment on palmrest according to the present invention; and

FIG. 5 is a front view of a suitable cushion according to the present invention.

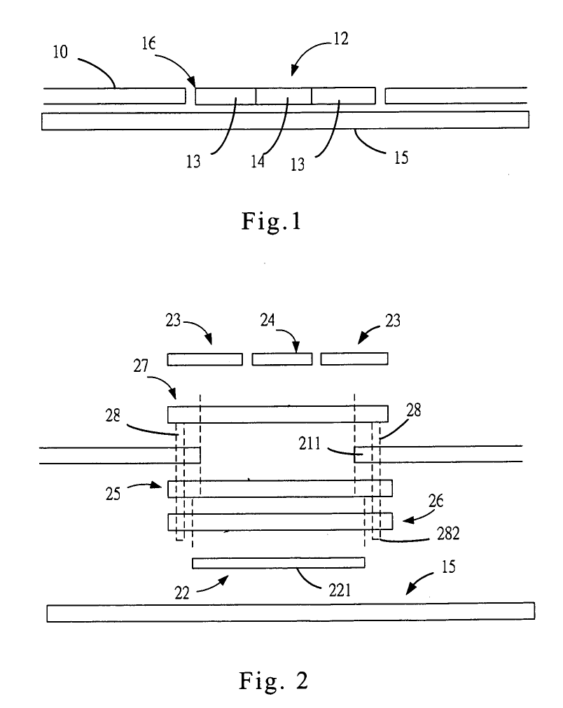

### DETAILED DESCRIPTION OF THE PREFERRED EMBODIMENT

The structures, the objects and effects of the notebook compute input equipment having waterproof and dustproof structure according to the invention will be detailedly described by the following embodiment.

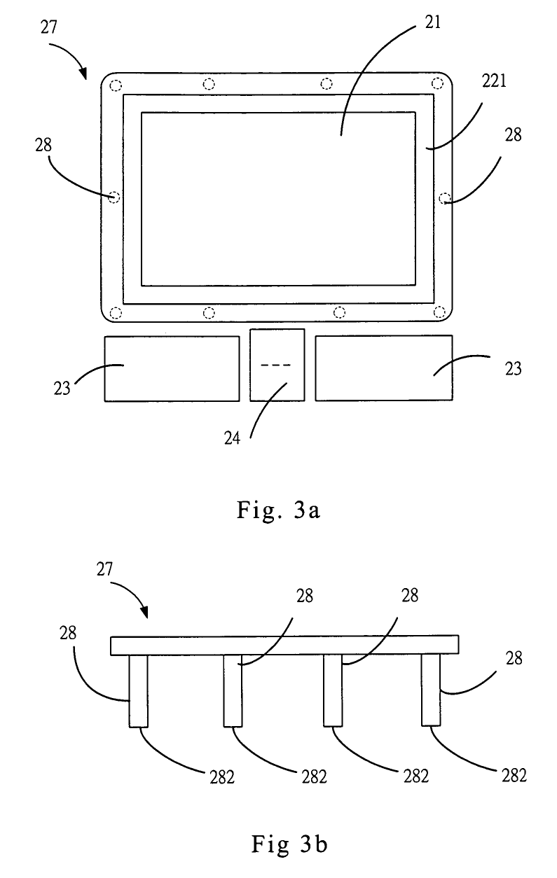

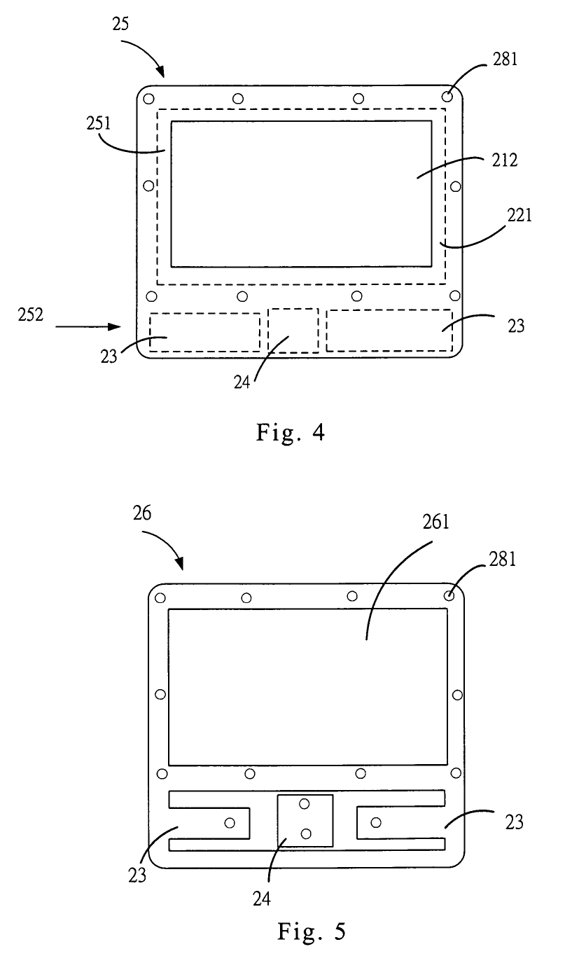

Referring to FIGS. 2-5, of the waterproof and dustproof input equipment for a notebook computer according to the invention includes an input equipment including input keys such as a touchpad 22, mouse keys 23 and reel keys 24 (as shown in FIG. 2). A suitable compressed frame 27 is located under input keys such as mouse keys and reel keys and provided with a prescribed hole 21 corresponding to touchpad 22 or several vertical fixing pillars 28 (as shown in FIG. 2, FIG. 3a and FIG. 3b). The effects of the fixing pillar 28 and corresponding fixing pillar prescribed hole 281 will be discussed in the following paragraph. At least a compressed bar 211 is located around prescribed hole 21 of the input equipment and under suitable compressed frame 27 or selectively includes fixing pillar prescribed hole 281 to cooperate with corresponding fixing pillar 28 of suitable compressed frame 27 (as shown in FIG. 2). A suitable cushion 25 is located under suitable compressed frame 27 and compressed bar 211 or includes selectively includes fixing pillar prescribed hole 281 to cooperate with corresponding fixing pillar 28 of suitable compressed frame 27 (as shown in FIGS. 2 and 4). A suitable compressed bar 26 located under suitable compressed cushion 25 includes a prescribed hole 21 to correspond to touchpad 22 or fixing pillar prescribed hole 281 to cooperate with corresponding fixing pillar 28 of suitable compressed frame 27 (as shown in FIGS. 2 and 5).

Accordingly, when the notebook computer input equipment having waterproof and dustproof structure according to the invention is assembled, firstly, suitable pressed framed 27 is arranged under input keys such as mouse keys 23 and reel keys 24. Following arranging touchpad 22 through under suitable compressed bar 26 by sequentially corresponding to compressed bar 211, suitable cushion 25 and suitable compressed bar 26 (each of them includes a prescribed hole to correspond to touchpad 22) located inside the peripheral of prescribed hole 21 of input equipment, a separated frame (not shown) is formed around suitable cushion 25 and suitable compressed frame 27. Such structure corresponds to input keys prescribe hole 21 of palmrest 20 and is connected to circuit board 15 so as to integrated with the notebook computer achieving waterproof and dustproof effects.

As shown in FIG. 2 to FIG. 5, suitable compressed frame 27 includes several fixing pillars 28 that cooperates with compressed bar 211, suitable cushion 25 and fixing bar prescribed hole 281 on suitable compressed bar 26 to achieve securing effects.

Although the present invention has been particularly shown and described above with reference to the preferred embodiment, it is anticipated that alterations and modifications thereof will no doubt become apparent to those skilled in the art. It is therefore intended that the following claims be interpreted as covering all such alteration and modifications as fall within the true spirit and scope of the present invention.

What is claimed is:

1. A notebook computer input equipment having waterproof and dustproof structure, comprising:
input keys comprising mouse function keys, reel keys and touchpad;
a compressed frame located under the mouse function keys and reel keys of the input equipment and comprising a prescribed hole on a middle part thereof to expose the touchpad, the prescribed hole having an area slightly smaller than an area of the touchpad;
a cushion located under the compressed frame and comprising a prescribed opening on a middle part thereof to expose the touchpad, the prescribed opening having an area slightly smaller than the area of the touchpad;
a compressed bar located under the compressed frame and above the touchpad of the input equipment and comprising a prescribed aperture on a middle part thereof to expose the touchpad, the prescribed aperture having an area slightly smaller than the area of the touchpad; and
a prescribed cavity located on a palmrest of the notebook computer;
wherein the input keys, the compressed frame, the cushion, the compressed bar and the palmrest are sequentially combined into an integrated body.

2. The notebook computer input equipment having waterproof and dustproof structure according to claim 1, wherein the compressed frame comprises a plurality vertical fixing pillars.

3. The notebook computer input equipment having waterproof and dustproof structure according to claim 1, wherein the cushion comprises a plurality of fixing pillar prescribed holes to cooperate with the fixing pillars of the compressed frame.

4. The notebook computer input equipment having waterproof and dustproof structure according to claim 1, wherein the compressed bar comprises a plurality of fixing pillar prescribed holes to cooperate with the fixing pillar of the compressed frame.

5. The notebook computer input equipment having waterproof and dustproof structure according to claim 1, wherein at least one compressed bar is located inside a peripheral of the prescribed cavity of the palmrest of the notebook computer and between the compressed frame and the cushion.

6. The notebook computer input equipment having waterproof and dustproof structure according to claim 5, wherein the compressed bar comprises a plurality of fixing pillar prescribed holes to cooperate with the fixing pillar of the compressed frame.
